(19) United States
(12) Patent Application Publication
(10) Pub. No.: US 2019/0263081 A1
(43) Pub. Date: Aug. 29, 2019

(54) METHODS AND MACHINES FOR MAKING PADDED ENVELOPES FROM ON DEMAND INFLATABLE PACKAGING

(71) Applicant: Automated Packaging Systems, Inc., Streetsboro, OH (US)

(72) Inventor: Rick Steven Wehrmann, Hudson, OH (US)

(21) Appl. No.: 16/275,538

(22) Filed: Feb. 14, 2019

Related U.S. Application Data
(60) Provisional application No. 62/630,477, filed on Feb. 14, 2018.

(51) Int. Cl. B31B 70/81; B31B 70/64; B65D 81/03; B31B 70/88

(52) U.S. Cl. CPC B31B 70/81; B31B 70/64; B31B 2155/002; B31B 70/88; B65D 81/03

(57) ABSTRACT

An exemplary method for converting a web of preformed pouches to at least one padded envelope includes moving the web along a path of travel, inserting a first inflation pin into a first inflation channel of a preformed pouch, and inserting a second inflation pin into a second inflation channel of the preformed pouch. In addition, the method includes inflating inflation patterns of each panel of the preformed pouch by providing air through at least one of the first inflation pin and the second inflation pin, such that the preformed pouch is in an inflated position. The method also includes simultaneously sealing the outer skin and each side panel of the preformed pouch to maintain the preformed pouch in the inflated position.

### RELATED APPLICATIONS

The present application claims the benefit of U.S. provisional patent application Ser. No. 62/630,477, filed on Feb. 14, 2018, titled “Methods and machines for making padded envelopes from on-demand inflatable packaging”, which is incorporated herein by reference in its entirety.

### BACKGROUND OF THE INVENTION

Bubble wrap is widely-used as a packaging material. One known use of bubble wrap is a cushioning material, for example, which can be wrapped around a product or within a larger package, such as within a box, corrugate, a bag, or paper. For example, cushioning material is used within the inside of a paper skin as a padded envelope.

A typical padded envelope includes cushioning material formed by a vacuum process that includes laminating or sealing two layers of plastic together. After the two layers of plastic are laminated or sealed together, a small amount of air is trapped within each bubble to create a cushioning characteristic.

Conventionally, a padded envelope is manufactured at an assembly site. At the assembly site, the cushioning material is formed and attached to the paper skin. The envelope may be shipped to a point of retail sale, or a product may be packed within the padded envelope at a packaging site. In either example, the padded envelopes are shipped in a final size and volume (i.e., with the inflation pattern fully inflated).

### SUMMARY

An exemplary apparatus for converting a web of preformed pouches to at least one padded envelope includes an indexing mechanism, a first inflation pin, a second inflation pin, and a sealing member. The indexing mechanism is configured to move the web of preformed pouches along a path of travel. The first inflation pin is configured to be placed into a first inflation channel of the web of preformed pouches and provide air into the first inflation channel to inflate a first inflation pattern of a first side panel of the preformed pouches. The second inflation pin is configured to be placed into a second inflation channel of the web of preformed pouches and provide air into the second inflation channel to inflate a second inflation pattern of a second side panel of the preformed pouches. The sealing member is configured to seal an outer skin, the first side panel, and the second side panel of the preformed pouches simultaneously.

Another exemplary apparatus for converting a web of preformed pouches to at least one padded envelope includes an indexing mechanism, a first inflation pin, a second inflation pin, and a sealing member. The indexing mechanism is configured to move the web of preformed pouches along a path of travel. The first inflation pin is configured to be placed into a first inflation channel of the web of preformed pouches and provide air into the first inflation channel to inflate a first inflation pattern of a first side panel of the preformed pouches. The second inflation pin is configured to be placed into a second inflation channel of the web of preformed pouches and provide air into the second inflation channel to inflate a second inflation pattern of a second side panel of the preformed pouches. The sealing member is configured to seal the first side panel to the second side panel such that the first and second inflation patterns of the preformed pouches are sealed. The sealing member is also configured to remove the preformed pouches from the web by using a heat trim that extends into at least one separation opening of the one or more separation openings.

An exemplary method for converting a web of preformed pouches to at least one padded envelope includes moving the web along a path of travel, inserting a first inflation pin into a first inflation channel of a preformed pouch, and inserting a second inflation pin into a second inflation channel of the preformed pouch. In addition, the method includes inflating inflation patterns of each panel of the preformed pouch by providing air through at least one of the first inflation pin and the second inflation pin, such that the preformed pouch is in an inflated condition. The method also includes simultaneously sealing the outer skin and each side panel of the preformed pouch to maintain the preformed pouch in the inflated condition.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments of the present disclosure will be described and explained with additional specificity and detail through the use of the accompanying drawings.

FIG. 1A is a front view of an exemplary inflatable packaging web;

FIG. 1B is a sectional view of the inflatable packaging web of FIG. 1A, taken along the plane indicated by line B-B of FIG. 1A;

FIG. 1C is a sectional view of the inflatable packaging web of FIG. 1A, taken along the plane indicated by line C-C of FIG. 1A;

FIG. 2A is an exemplary embodiment of a padded envelope created from the inflatable packaging web of FIGS. 1A-1C;

FIG. 2B is a sectional view of the padded envelope of FIG. 2A, taken along the plane indicated by line B-B of FIG. 2A;

FIG. 3A is a front view of an exemplary embodiment of a packaging machine for creating padded envelopes from the inflatable packaging web of FIG. 1;

FIG. 3B is a top view of the packaging machine of FIG. 3A;

FIG. 3C is a sectional view of the packaging machine of FIG. 3A, taken along the plane indicated by line C-C of FIG. 3A;

FIG. 4A is a front view of the packaging machine and the inflatable packaging web positioned in the packaging machine to create a padded envelope;

FIG. 4B is a top view of the packaging machine and inflatable packaging web of FIG. 4A;

FIG. 4C is a sectional view of the packaging machine and inflatable packaging web of FIG. 4A, taken along the plane indicated by line C-C of FIG. 4A;

FIG. 5A is a front view of the packaging machine showing an inflatable pouch being removed from the inflatable packaging web;

FIG. 5B is a top view of the packaging machine and inflatable packaging web of FIG. 5A;

FIG. 5C is a sectional view of the packaging machine and inflatable packaging web of FIG. 5A, taken along the plane indicated by line C-C of FIG. 5A;

FIG. 6A is a front view of the packaging machine showing a product being inserted into a removed inflatable pouch of the inflatable packaging web;

FIG. 6B is a top view of the packaging machine and inflatable packaging web of FIG. 6A;

FIG. 6C is a sectional view of the packaging machine and inflatable packaging web of FIG. 6A, taken along the plane indicated by line C-C of FIG. 6A;

FIG. 7A is a front view of the packaging machine showing a sealing member of the packaging machine partially closed on the removed inflatable pouch of the inflatable packaging web;

FIG. 7B is a top view of the packaging machine and inflatable packaging web of FIG. 7A;

FIG. 7C is a sectional view of the packaging machine and inflatable packaging web of FIG. 7A, taken along the plane indicated by line C-C of FIG. 7A;

FIG. 8A is a front view of the packaging machine showing the removed inflatable pouch of the inflatable packaging web being inflated;

FIG. 8B is a top view of the packaging machine and inflatable packaging web of FIG. 8A;

FIG. 8C is a sectional view of the packaging machine and inflatable packaging web of FIG. 8A, taken along the plane indicated by line C-C of FIG. 8A;

FIG. 9A is a front view of the packaging machine showing the sealing member closing and sealing the removed inflatable pouch of the inflatable packaging web;

FIG. 9B is a top view of the packaging machine and inflatable packaging web of FIG. 9A;

FIG. 9C is a sectional view of the packaging machine and inflatable packaging web of FIG. 9A, taken along the plane indicated by line C-C of FIG. 9A;

FIG. 10A is a front view of the packaging machine showing the removed inflatable pouch of the inflatable packaging web being removed from the packaging machine as a padded envelope;

FIG. 10B is a top view of the packaging machine and inflatable packaging web of FIG. 10A;

FIG. 10C is a sectional view of the packaging machine and inflatable packaging web of FIG. 10A, taken along the plane indicated by line C-C of FIG. 10A;

FIG. 11A is a front view of the packaging machine showing the inflatable packaging web being advanced through the packaging machine to place the next inflatable pouch in position for creating another padded envelope;

FIG. 11B is a top view of the packaging machine and inflatable packaging web of FIG. 11A;

FIG. 11C is a sectional view of the packaging machine and inflatable packaging web of FIG. 11A, taken along the plane indicated by line C-C of FIG. 11A;

FIG. 12A is a front view of an exemplary embodiment of a packaging machine for creating padded envelopes from the inflatable packaging web of FIG. 1 with labels printed on the padded envelope;

FIG. 12B is a top view of the packaging machine of FIG. 12A;

FIG. 12C is a sectional view of the packaging machine of FIG. 12A, taken along the plane indicated by line C-C of FIG. 12A.

### DETAILED DESCRIPTION

This Detailed Description merely describes exemplary embodiments in accordance with the general inventive concepts and is not intended to limit the scope of the invention or the claims in any way. Indeed, the invention as described by the claims is broader than and unlimited by the exemplary embodiments set forth herein, and the terms used in the claims have their full ordinary meaning.

The general inventive concepts will now be described with occasional reference to the exemplary embodiments of the invention. These general inventive concepts may, however, be embodied in different forms and should not be construed as limited to the embodiments set forth herein. Rather, these embodiments are provided so that this disclosure will be thorough and complete, and will fully convey the scope of the general inventive concepts to those skilled in the art.

Unless otherwise defined, all technical and scientific terms used herein have the same meaning as commonly understood by one of ordinary skill in the art encompassing the general inventive concepts. The terminology set forth in this Detailed Description is for describing particular embodiments only and is not intended to be limiting of the general inventive concepts. As used in this Detailed Description and the appended claims, the singular forms “a,” “an,” and “the” are intended to include the plural forms as well, unless the context clearly indicated otherwise.

Unless otherwise indicated, all numbers expressing quantities of ingredients, properties such as molecular weight, reaction conditions, percentages and so forth as used in the specification and claims are to be understood as being modified in all instances by the term “about.” Accordingly, unless otherwise indicated, the numerical properties set forth in the specification and claims are approximations that may vary depending on the suitable properties sought to be obtained in embodiments of the present invention. Notwithstanding that the numerical ranges and parameters setting forth the broad scope of the general inventive concepts are approximations, the numerical values set forth in the specific examples are reported as precisely as possible. Any numerical values, however, inherently contain certain errors necessarily resulting from error found in their respective measurements.

When discussing the invention, a final packaging product is discussed. For exemplary purposes, a padded mailer envelope is discussed. However, it should be apparent to one with ordinary skill in the art that the invention may be practiced with other packaging products, such as, for example, paper or plastic bags, paper or plastic mailers, corrugate mailers, and other known packaging offerings in which the inside of the package may be lined with cushioning material.

The present application is directed towards machines and methods for producing inflated padded envelopes from a web of preformed, inflatable pouches. Each preformed pouch of the web of preformed pouches can be defined by side edges and two panels, in which at least one panel has an inflation pattern. The web can also include one or more inflation channels that are in fluid communication with the inflation pattern(s) of each preformed pouch. An outer skin may be attached to the outside of the web, or an outside surface of the panels may be smooth to act as an outer skin. The web of preformed pouches are inflatable at a later time for assembly of a padded envelope, either with or without a product being deposited in the preformed pouch, and the product being deposited before or after the preformed pouch is inflated.

The web of preformed, inflatable pouches allows the inflating of the padded envelope to be delayed, such as, for example, until the end user of the envelope deposits a product into the pouch. The padded envelope can be separated from the web either before or after the padded envelope is inflated. This method allows more padded envelopes, in a non-inflated condition, to be shipped having a specific volume and weight, as compared to inflated padded envelopes. Also, a final user of the padded envelopes, such as a packer of a product, can produce only the amount of inflated padded envelopes needed for a certain packaging run, and thus enjoy efficiencies of just-in-time production and reduction of envelope inventory.

In one embodiment of the invention, a method converts a web of inflatable, preformed pouches into inflated padded envelopes. Each pouch of the web includes side edges, two panels, and an opening, in which each panel has an inflation pattern. The web also includes two inflation channels that are in fluid communication with the inflation pattern(s), and an outer skin can be attached to the outside of the web. In one embodiment, the inflation pattern of each panel and both inflation channels are in fluid communication with each other. In an alternative embodiment, the inflation pattern of one panel is in fluid communication with one inflation channel, and the inflation pattern of the other panel is in fluid communication with the other inflation channel, but the inflation patterns are not in fluid communication with each other.

Referring now to the exemplary method, the web of preformed pouches is moved along a path of travel, and a preformed pouch is removed from the web of preformed pouches. The two inflation channels can remain intact after the preformed pouch is removed from the web of preformed pouches, or the portions of the inflation channels that are adjacent to the removed preformed pouch can be separated from the portions of the inflation channels associated with the remainder of the web. The removed preformed pouch is inflated by providing air through the inflation channels and into the inflation patterns of each panel. The method also includes depositing a product into the removed preformed pouch, and sealing the opening of the removed pouch. The preformed pouch can be removed from the web prior to being inflated or after being inflated, and the product can be deposited into the preformed pouch prior to being inflated or after being inflated. After the preformed pouch is inflated and a product is deposited into the preformed pouch, the preformed pouch is sealed such that the product is sealed in an interior of the inflated preformed pouch. The preformed pouch can be sealed prior to being removed from the web or after being removed from the web. In certain embodiments, the preformed pouch is separated from the inflation channels by a heat trim such that a final padded envelope is created. In an alternative embodiment, one or more cutting members (e.g., knives, blades, etc.) can be used to cut the inflation channels such that the final padded envelope is created.

The web of preformed pouches may be of a variety of forms in the practice of the invention. The web may be an inflatable cushioning material designed to be inflated initially, flattened, and inflated or reinflated at a later time by an end user to create padded envelopes. An exemplary material is FASTWRAP™, manufactured and marketed by Automated Packaging Systems of Streetsboro, Ohio. Another exemplary material is described in U.S. Pat. No. 6,423,166, which is incorporated herein by reference in its entirety. The end user inflates this material on-demand and inflates only the number of padded envelopes that are required at that time.

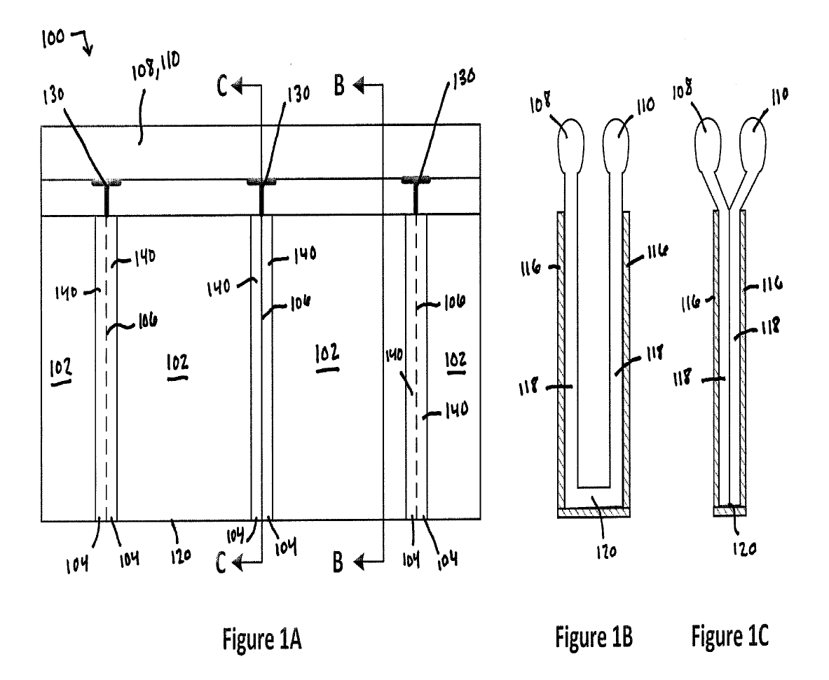

Referring to FIGS. 1A-1C, an exemplary embodiment of an inflatable packaging web 100 includes a string of side connected inflatable pouches 102. Each inflatable pouch 102 is connected to one another at side edges 104. The exemplary side edges 104 include lines of perforations 106 to facilitate separation of an inflatable pouch 102 from an adjacent inflatable pouch on the inflatable packaging web. The lines of perforations 106 can be configured in a variety of different ways. For example, the lines of perforations 106 can be spaced apart, can include cuts, can be configured to tear at a center portion, can include curved seals at a bottom portion, or can be configured in various other suitable ways. Each pouch 102 includes at least one inflatable panel 118. The inflatable panel 118 may take any suitable form, such as, for example, any form described in U.S. Patent Publication No. 2014/0260094, which is incorporated herein by reference in its entirety. The panels 118 may be made from the web disclosed in U.S. Pat. No. D596,031 or the web disclosed in U.S. Pat. No. 6,423,166, each of which are incorporated by reference in their entirety.

An exemplary inflatable packaging web 100 includes two or more pouches 102. Each pouch 102 is formed by sealing a pair of panels together along a bottom edge 120 and side edges 104 or by folding a larger panel in half along the bottom edge 120 and sealing the side edges 104. One or both of the panels 118 have an inflation pattern (not shown), such as, for example, any inflation pattern described in U.S. Patent Publication No. 2014/0260094, which is incorporated herein by reference in its entirety. The inflatable packaging web 100 can also include an outer skin 116. The outer skin 116 can be attached to each pouch 102 at the side edges 104, and the outer skin can be unattached at areas between the side edges. In another embodiment, the outer skin 116 can be attached to each pouch at the side edges 104 and the bottom edge 120, and the outer skin 116 can be unattached at the areas between the side edges and the bottom edge. Alternatively, the inflatable packaging web 100 does not have an outer skin, but rather an outside surface of the panels 118 can be smooth to act as an outer skin. The outer skin 116 can be made of any thin material of suitable strength. Exemplary materials for the outer skin 116 include paper and plastic, and the material may be printable. For example, a plastic skin may be imprinted with indicia, such as, for example, trademark information, product measurements, instructions, and barcoding data. The outer skin 116 is configured to remain sufficiently smooth after all manufacturing steps so that the bar code is readable by a scanner.

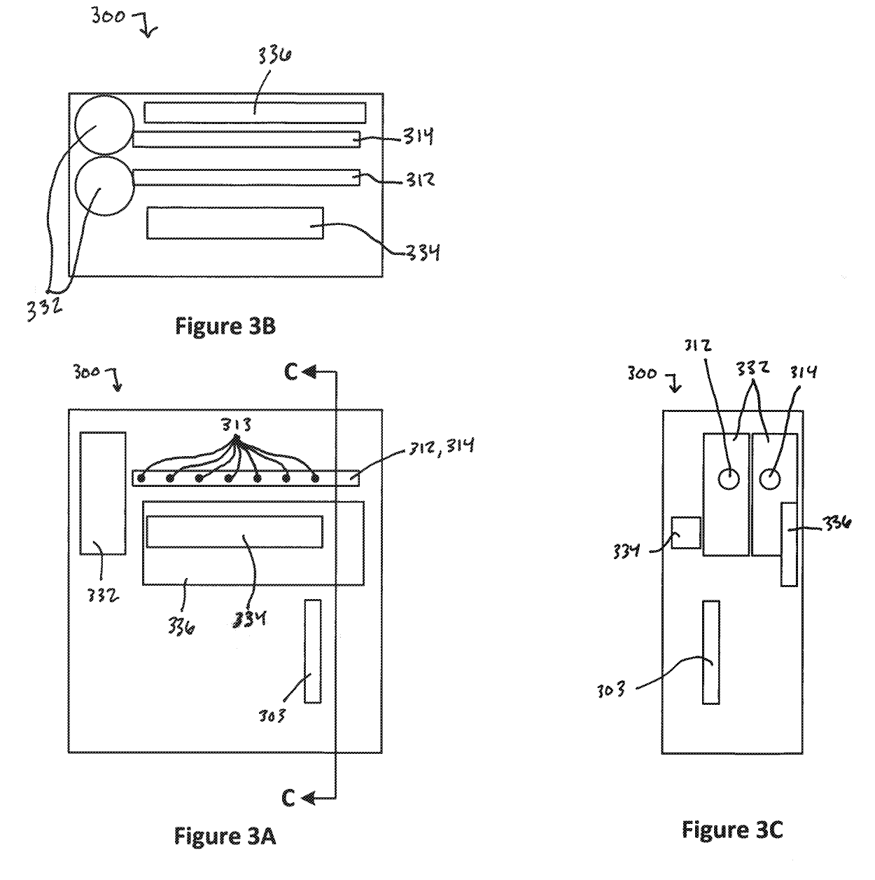

One or both of the panels 118 include an inflation channel 108, 110. The inflation channels 108, 110 allows the preformed pouch 102 to be inflated by inflation pins 312, 314 (FIGS. 3A-3C) that are inserted into the inflation channels. The side edges 104 include seals 140 that are closed to maintain the inflation in the pouch 102. In the illustrated embodiment, the exemplary inflatable packaging web 100 includes a first inflation channel 108 and a second inflation channel 110. The first inflation channel 108 is in fluid communication with one panel 118, such that the first inflation channel is used to inflate the panel. The second inflation channel 110 is in fluid communication with the other panel 118, such that the second inflation channel is used to inflate the panel. In certain embodiments, the panels 118 are in fluid communication with each other, such that one or both inflation channels 108, 110 can be used to inflate both panels 118. In other embodiments, the panels 118 are sealed along the bottom edge 120, such that the panels are not in fluid communication with each other. The inflation channels 108, 110 can be as described in any one or more of U.S. Pat. Nos. 6,423,166; 8,357,439; D646,972; 8,038,348, each of which are incorporated herein by reference in their entirety.

Still referring to FIGS. 1A-1C, the inflatable packaging web 100 can include one or more separation openings 130. In the illustrated embodiment, a separation opening 130 is provided on the web 100 at a position above the outer skin 116, below the inflation channels 108, 110, and substantially in line with an axis of the lines of perforations 106. The separation openings 130 are configured such that each inflatable pouch 102 can be separated from the inflation channels 108, 110 after the inflatable pouch is made into a padded envelope. That is, the inflatable pouches 102 are separated from each other by the lines of perforations 106, but the lines of perforations do not extend into the inflation channels 108, 110. Therefore, the separation openings 130 are placed in a position to facilitate separation of the pouches 102 from the inflation channels 108, 110.

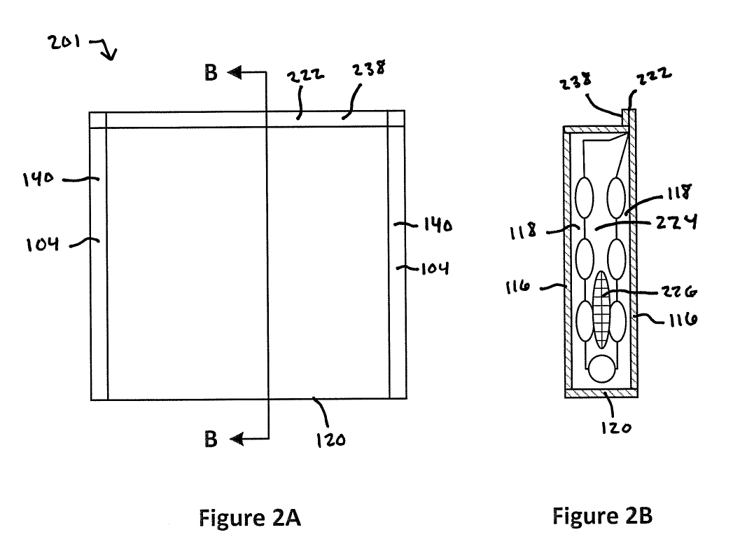

Each pouch 102 of the inflatable packaging web 100 can be inflated to produce padded envelopes. For example, FIGS. 2A and 2B illustrate a padded envelope 201 created from a pouch 102 of the inflatable packaging web 100. The padded envelope 201 is sealed at the side edges 104, the top edge 222, and the bottom edge 120 such that the interior 224 of the padded envelope is an enclosed space defined by the sealed edges and the panels 118. A seal 238 at the top edge 222 of the padded envelope is created such that both the outer skin 116 and the panels 118 are sealed along a common axis. The seal 238 also keeps the padded envelope 201 in an inflated condition. At least one of the panels 118 is inflated to create a padding on the interior 224 of the padded envelope 201. In the illustrated embodiment, both panels 118 are inflated. Prior to the top edge 222 being sealed with seal 238, a product 226 can be placed in the interior of the inflatable pouch such that, after the top edge is sealed, the product is located in the interior 224 of the padded envelope 201. The inflated panels 118 provide a cushioning to the product 226 to protect the product from being broken during shipping.

Referring to FIGS. 3A-3C, an exemplary embodiment of a packaging machine 300 for converting an inflatable packaging web 100 (FIGS. 1A-1C) into individual padded envelopes 201 (FIGS. 2A and 2B) includes an indexing mechanism 332, a first inflation pin 312, a second inflation pin 314, a sealing member 334, and a backing bar 336. The first inflation pin 312 is configured to be inserted into the first inflation channel 108 of the inflatable packaging web 100, and the second inflation pin 314 is configured to be inserted into the second inflation channel 110 of the inflatable packaging web. The inflation pins 312, 314 are also configured to supply air into the inflation channels 108, 110 to inflate the panels 118 of the inflatable packaging web 100. The inflation pins 312, 314 can take any suitable form, such as, for example, elongated tubes with an air inlet and outlet holes of openings 313. Air enters the tubes through the inlet 311 and exits the tube through the outlet holes or openings 313, which causes the air to enter the inflation channels 108, 110 to fill the pouches 102 of the web 100. In certain embodiments, the portion of the panels 118 that align with the openings 313 of the inflation pins 312, 314 is reduced (e.g., by sealing a portion of the opening of the panels) such that air is prevented from exiting the panels during or after inflation of the panels. The indexing mechanism 332 is configured to move the inflatable packaging web 100 along a path of travel. For example, the indexing mechanism 332 is configured to move the web 100 along the inflation pins 312, 314. The indexing mechanism 332 can take any suitable form that is capable of moving an inflatable packaging web 100 along a path of travel, such as, for example, the indexing mechanism can comprise driven rollers (as illustrated), belts, etc.

The sealing member 334 is configured to close and seal the inflatable pouches 102 of the web 100 to create a padded envelope 201. That is, the sealing member 334 is configured to create the seal 238 (FIGS. 2A and 2B) at the top edge 222 of the padded envelope 201. The backing bar 336 is positioned and configured to provide a backing surface for the sealing member 334, such that the sealing member presses the inflatable packaging web 100 against the backing bar, and the sealing member creates a seal 238 to a pouch 102 of the inflatable packaging web. In addition, the sealing member 334 can be configured to provide a heat trim to remove a padded envelope 201 from the inflation channels 108, 110 of the inflatable packaging web 100. In certain embodiments, the heat trim by the sealing member 334 extends between adjacent separation openings 130 of a pouch 102 to remove the pouch from the inflation channels 108, 110 as a padded envelope 201. The sealing member can take any suitable form that is capable of providing seal 238 to the top edge 222 of the padded envelope 201, such as, for example, a heated wire, a heated bar, etc. Alternatively, a cutting member (e.g., a knife, blade, etc.) can be used to remove a pouch 102 from the web 100 as a padded envelope 201.

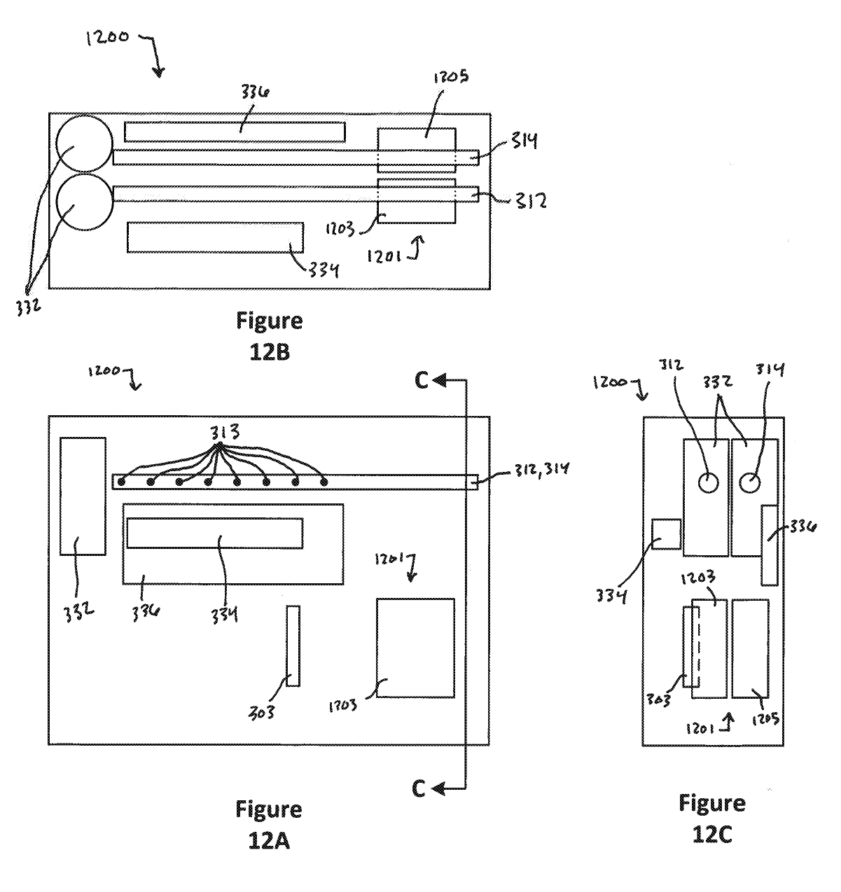

Referring to FIGS. 12A-12C, another exemplary embodiment of a packaging machine 1200 for converting an inflatable packaging web 100 (FIGS. 1A-1C) into padded envelopes 201 (FIGS. 2A and 2B) includes an indexing mechanism 332, a first inflation pin 312, a second inflation pin 314, a sealing member 334, a backing bar 336, and a printing mechanism 1201. The indexing mechanism 332, first inflation pin 312, second inflation pin 314, sealing member 334, and backing bar 336 of the packaging machine 1200 can take the same form described with reference to packaging machine 300 shown in FIGS. 3A-3C. The printing mechanism 1201 is positioned to engage the inflatable packaging web 100 prior to the packaging web being inflated such that the printing mechanism 1201 can print indicia on the inflatable pouches 102 (e.g., on the outside skin 116 or on one or more of the panels 118). By printing on the packaging web 100 before inflation, the web can be completely flattened for printing. For example, the printing mechanism 1201 can print product name, product type, expiration date, company name, lot number, ingredient list, nutritional values, shipping address, sender address, postage, third party shipping payment (i.e. UPS payment), tracking information, trademark information, product measurements, instructions, bar codes containing any bar coded information, QR codes containing a variety of different types of information, etc. onto the inflatable pouches 102. The printing mechanism 1201 can take any suitable form that is capable of printing indicia onto the inflatable pouches.

In the illustrated embodiment, the printing mechanism 1201 includes a printer 1203 and a printer backing bar 1205. The printer 1203 can take any suitable form, such as, for example, an ink jet printer, laser jet printer, film transfer printer, thermal transfer printer, etc. The printer backing bar 1205 is positioned and configured to provide a backing surface for the printer 1203, such that the printer 1203 presses the inflatable packaging web 100 against the backing bar 1205 when the printer 1203 is printing indicia onto the pouches 102.

The web 100 moves in between the printer 1203 and the printer backing bar 1205 prior to moving into position to be inflated by the inflation pins 312, 314. In the illustrated embodiment, the inflation pins 312, 314 are positioned to receive the web 100 prior to the web engaging the printing mechanism 1201, and after a preformed pouch 102 of the web 100 is engaged by the printing mechanism 1201 such that indicia is printed on the preformed pouches, the web is moved by the indexing mechanism 332 such that the preformed pouch is positioned on the openings 313 of the inflation pins 312, 314.

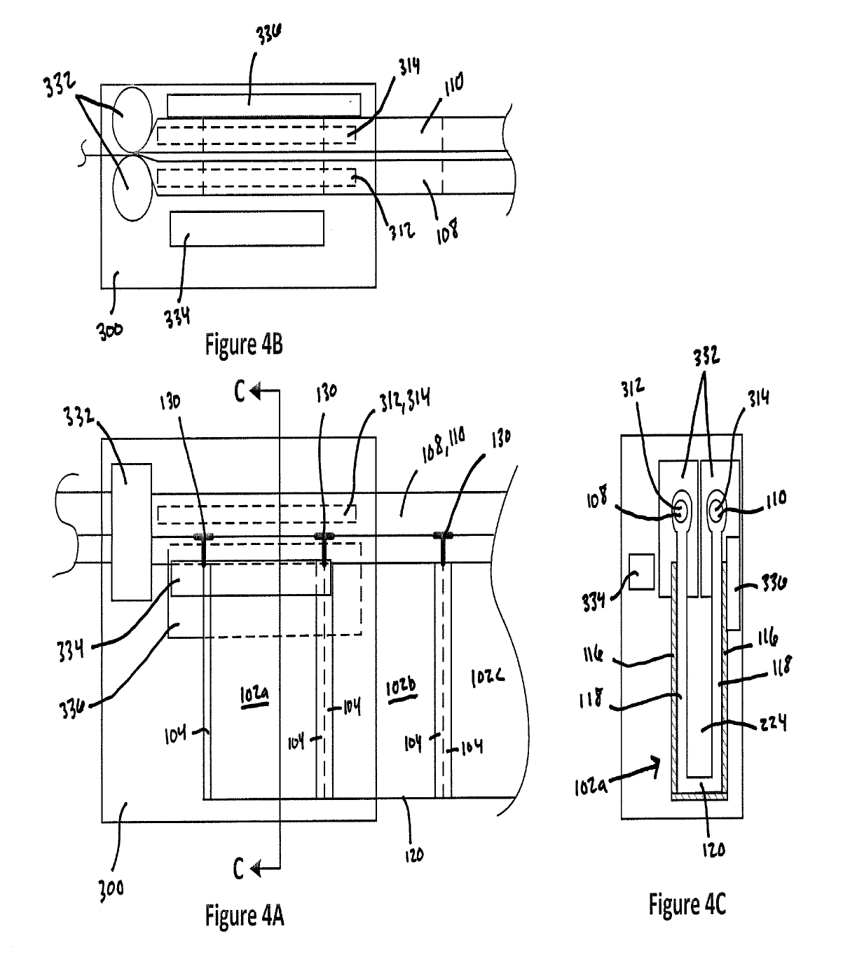

FIGS. 4A-11C illustrate an exemplary method for converting an inflatable packaging web 100 (FIGS. 1A-1C) into padded envelopes 201 (FIGS. 2A-2B) using a packaging machine 300 (FIGS. 3A-3C). While the method is described with reference to packaging machine 300 described in FIGS. 3A-3C, it should be understood that the method can also be performed using the packaging machine 1200 described in FIGS. 12-12C. Referring to FIGS. 4A-4C, the packaging web 100 is shown in the packaging machine 300 such that a first pouch 102a is in a position to be formed into a padded envelope 201. In particular, the first pouch 102a is placed in the packaging machine 300 such that the inflation pins 312, 314 are placed inside the inflation channels 108, 110 above the first pouch 102a, and such that the first pouch 102a is aligned with the sealing member 334.

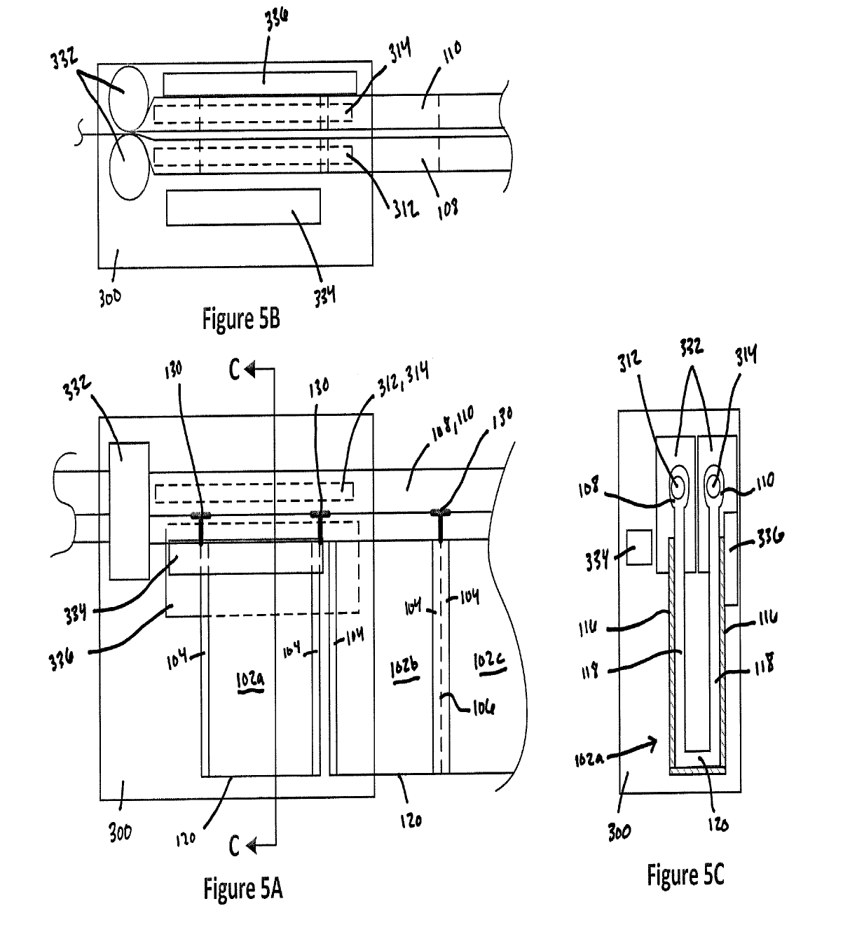

Referring to FIGS. 5A-5C, after the first pouch 102a of the inflatable packaging web 100 is placed in the position provided in FIGS. 4A-4C, the line of perforations 106 between the first pouch 102a and the second pouch 102b is broken to separate the first pouch from the second pouch. The line of perforations 106 can be broken by any suitable manner. For example, a bursting member 303 (FIG. 3) can be used to break the line of perforations 106. The bursting member can be, for example, one or more rotating wheels, one or more rotating wheels with radially outward extending projections, a blunt object, a knife, or any other suitable device that is capable of breaking the line of perforations 106. Alternatively, the perforations 106 can be left intact and the packages can be separated in a downstream operation or manually. After the line of perforations 106 between the first pouch 102a and the second pouch 102b, the side edges 104 of the first pouch 102a and the side edges 104 of the second pouch 102b are no longer connected, but the first pouch 102a is still connected to the web 100 by the inflation channels 108, 110. In other embodiments, the line of perforations 106 between the first pouch 102a and the second pouch 102b can be broken prior to the first pouch 102a being placed in position provided in FIGS. 4A-4C.

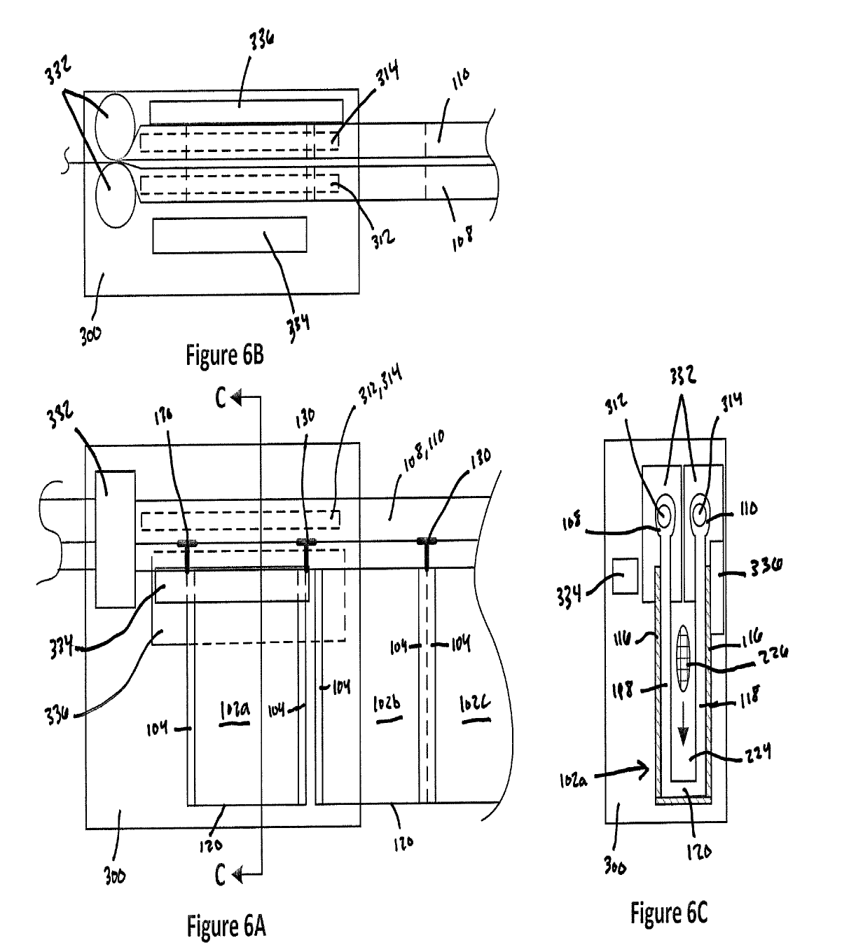

Referring to FIGS. 6A-6C, after the line of perforations 106 between the first pouch 102a and the second pouch 102b of the inflatable packaging web 100 is optionally broken, a product 226 can be inserted into an interior 224 of the first pouch 102a. The product 226 can be any object suitable for being delivered in a padded envelope 201. While the product is shown being inserted into the first pouch 102a after the line of perforations 106 between the first pouch 102a and the second pouch 102b is broken, it should be noted that the product can be placed in the interior 224 of the first pouch 102a at any step of the described method in which first pouch 102a is not in a sealed and closed position.

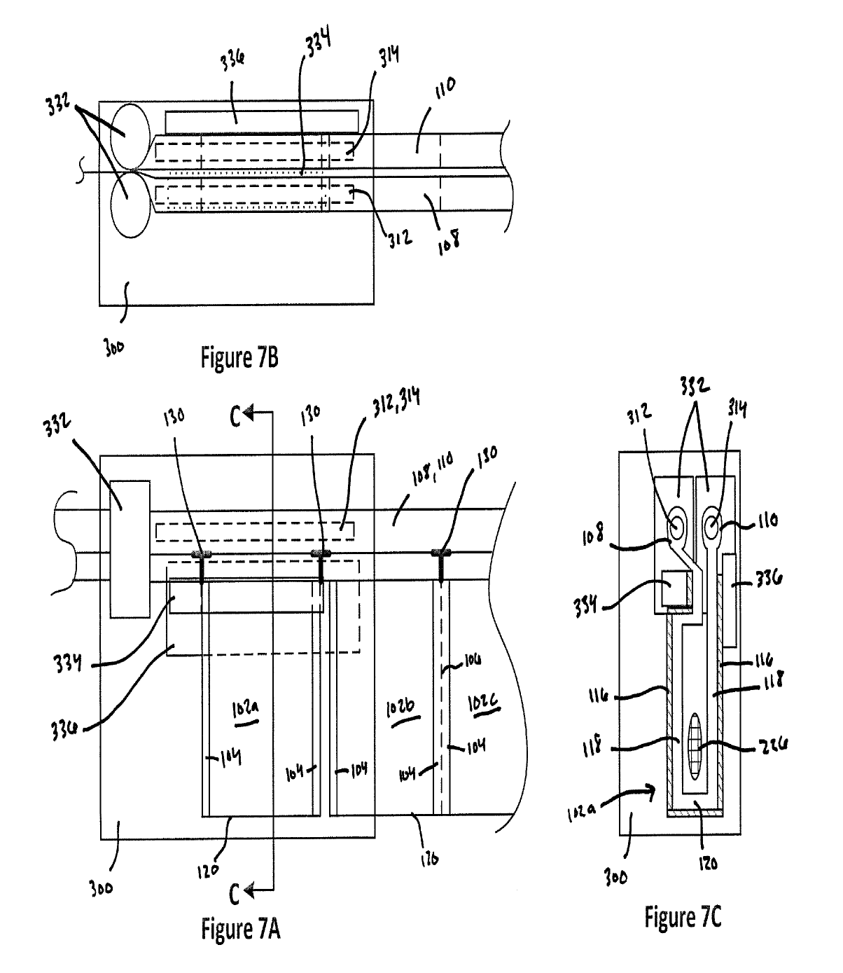

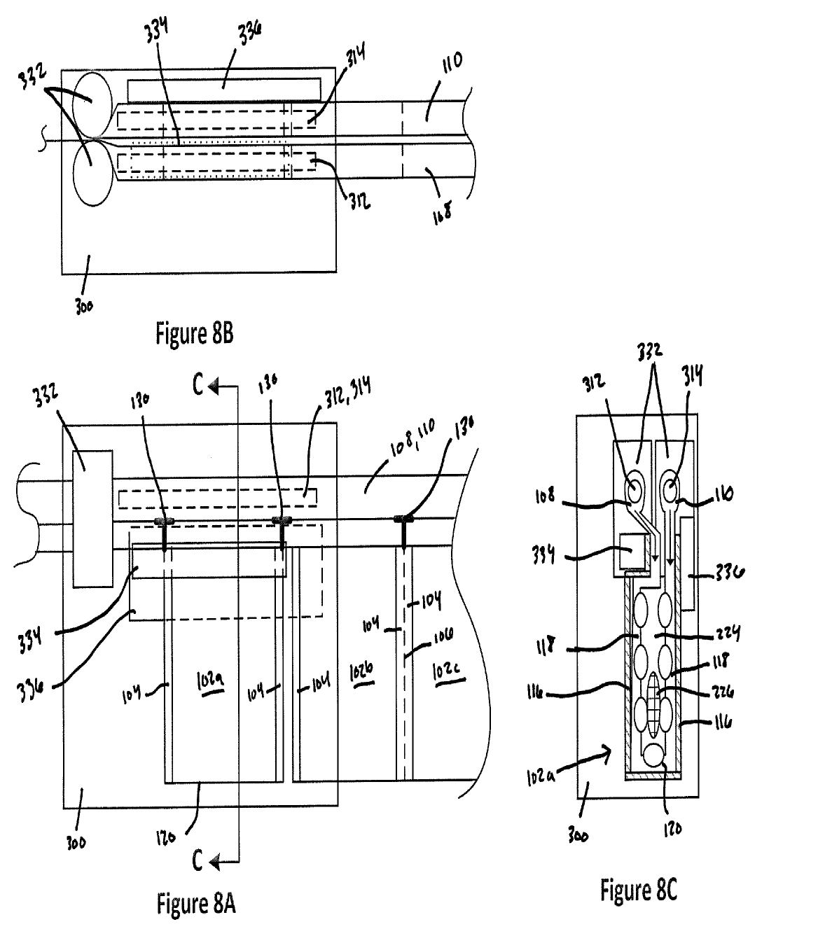

Referring to FIGS. 7A-7C, after the product 226 is placed in the interior 224 of the first pouch 102a, the sealing member 334 is used to partially close the pouch (which is shown best in FIG. 7C). Referring to FIGS. 8A-8C, after the first pouch 102a is partially closed by the sealing member 334, air is blown from the inflation pins 312, 314 through the inflation channels 108, 110 and into the panels 118 to inflate the first pouch 102a. The first pouch 102a is partially closed to prevent air from exiting the panels 118 during the inflation and/or sealing of the panels. In certain embodiments, if the panels 118 of the first pouch are in fluid communication with each other, both of the panels can be inflated by one of the two inflation pins 312, 314. In embodiments in which only one of the panels 118 has an inflation pattern, only the inflation pin 312, 314 in fluid communication with the panel with the inflation pattern is used to inflate the inflatable panel. In the illustrated embodiment, the sealing member 334 is moved toward the backing member 336, and the backing member 336 remains in a stationary position. In alternative embodiments, both the sealing member 334 and the backing member 336 are moved toward each other, such that the pouch 102a is closed (or partially closed) substantially near a mid-point of the pouch.

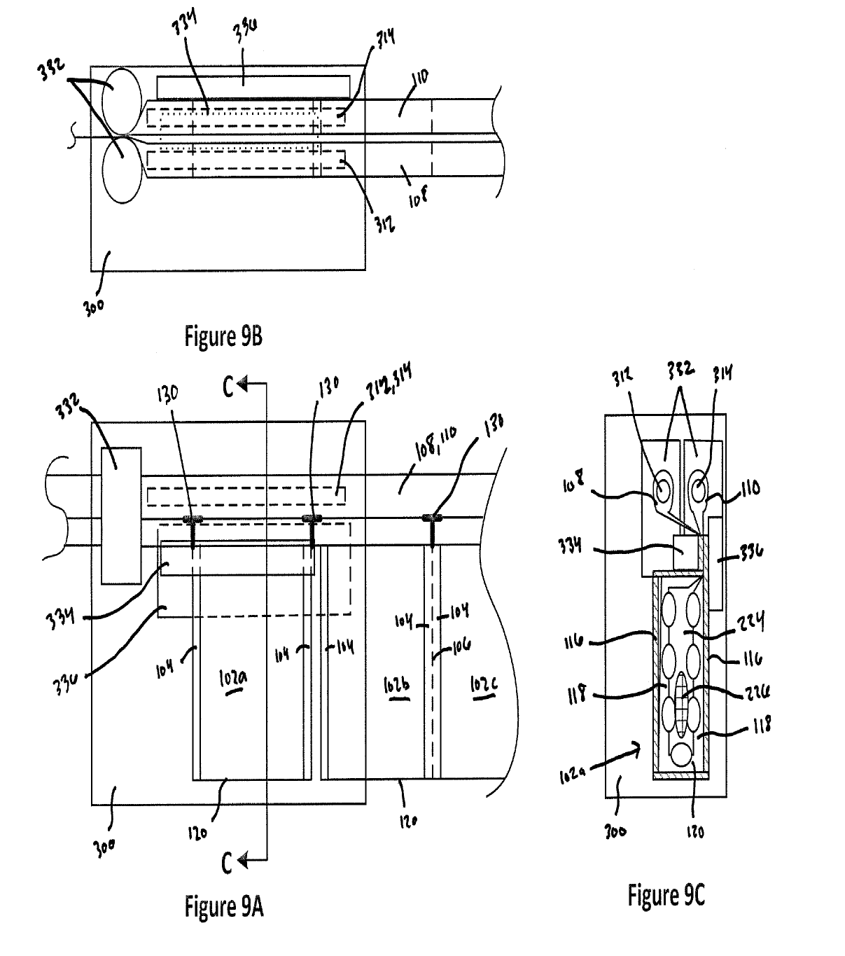

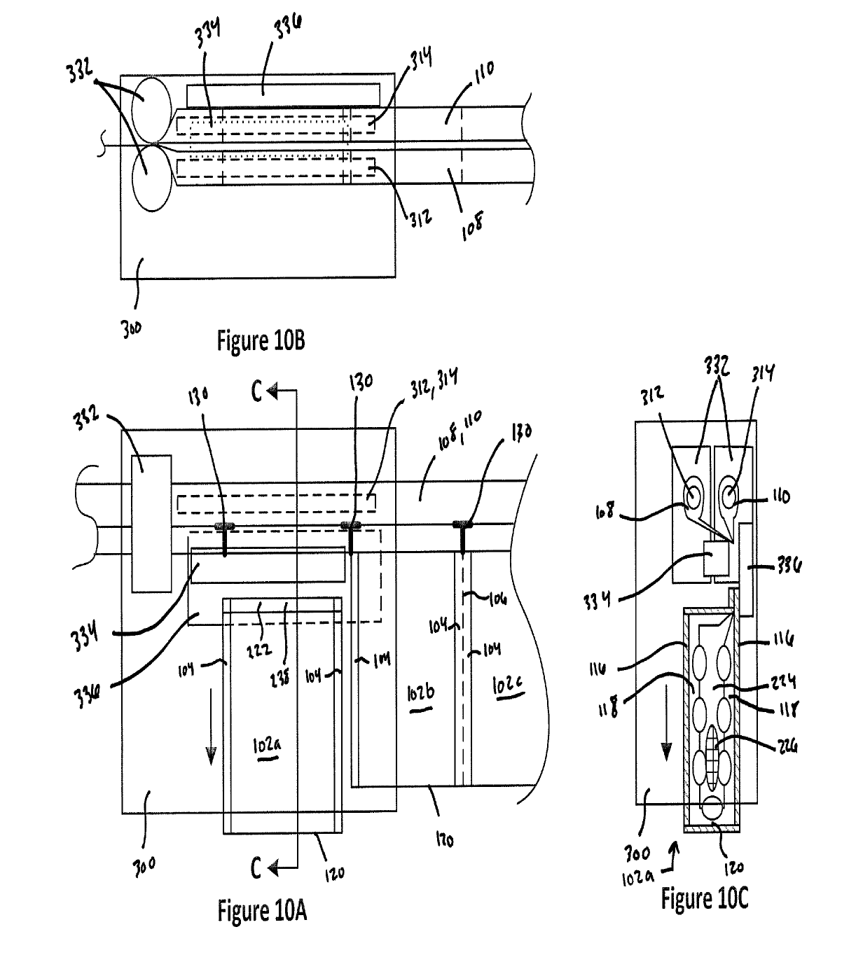

Referring to FIGS. 9A-9C, after the panels 118 of the first pouch 102a are inflated, the sealing member 334 is used to close and seal the pouch. In particular, the sealing member 334 pushes the first pouch 102a against the backing bar 336 and creates a seal 238 (FIGS. 2A and 10A) on the first pouch to keep the panels 118 in an inflated position and the pouch closed. The seal 238 created by the sealing member 334 seals the panels 118 and the outer skin 116 at the same time, which is advantageous because the pouches 102 are both closed and sealed (to create padded envelopes 201) in a single operation. The sealing member 334 can take any suitable form that is capable of creating the seal 238, such as, for example, a heated wire, a heated bar, etc. The backing bar 336 can take any suitable form capable of providing support for the sealing member 334, such as, for example, a metal, plastic, or rubber-like bar. After the first pouch 102a is sealed and closed, the interior 224 of the pouch 102a is enclosed and defined by the seals 140 at the side edges 104, the seal 238 at the top edge 222, and the bottom edge 120. In the illustrated embodiment, the sealing member 334 is moved toward the backing member 336, and the backing member 336 remains in a stationary position. In alternative embodiments, both the sealing member 334 and the backing member 336 are moved toward each other, such that the pouch 102a is sealed and closed substantially near a mid-point of the pouch.

Referring to FIGS. 10A-10C, after the first pouch 102a is sealed and closed by the sealing member 334, the sealing member is used to separate the first pouch from the inflation channels 108, 110 to optionally remove the pouch from the web 100 as a padded envelope 201. That is, the sealing member 334 uses a heat trim to separate the pouch 102a from the inflation channels 108, 110. The heat trim extends between the separation openings 130 associated with the first pouch 102a. Because the heat trim extends into the separation openings 130, the first pouch 102a is removed from the web 100 as a padded envelope 201. Alternatively, a cutting member (e.g., a knife, blade, etc.) can be used to cut between the separation openings 130 to remove the first pouch 102a from the web 100. In some embodiments, a cutting member (e.g., a knife, blade, etc.) can be used to cut the inflation channels 108, 110 to remove the first pouch from the web, or the inflation channels can include lines of perforations and a blunt object can be used to remove the first pouch from the web. In certain embodiments, the channels 108, 110 are left on the completed envelope.

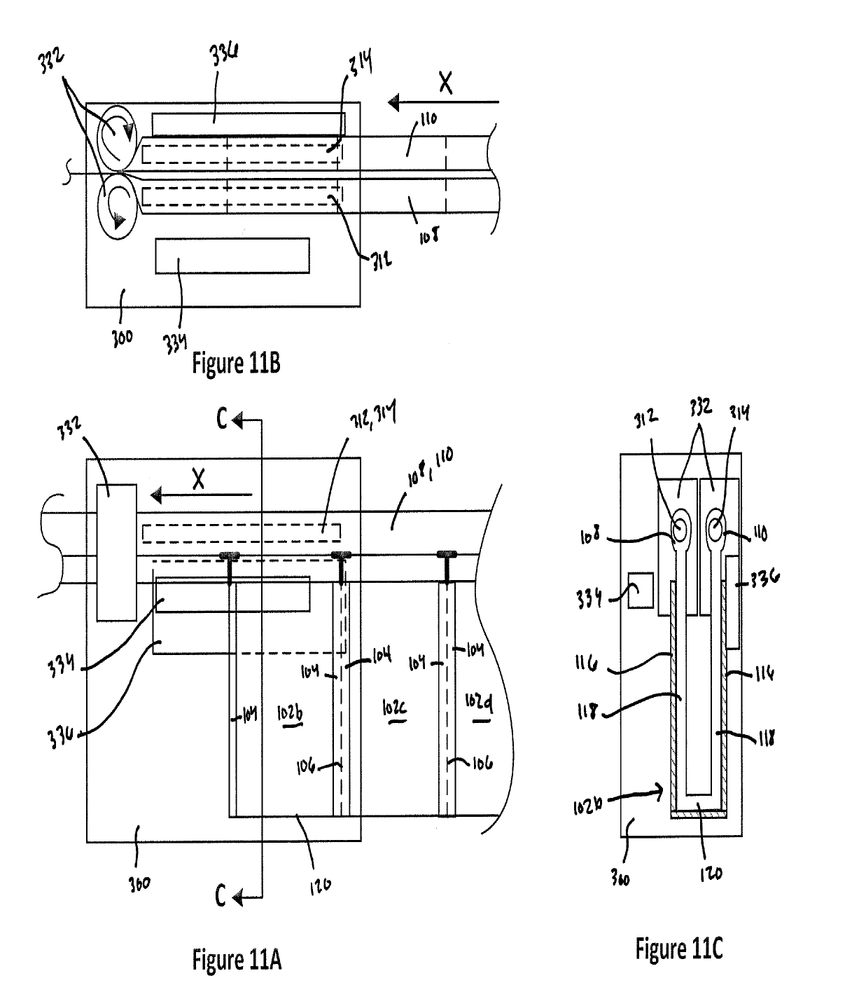

Referring to FIGS. 11A-11C, after the first pouch 102a is removed from the web 100 as a padded envelope 201, the sealing member 334 is moved to an unengaged position, and the indexing mechanism 332 moves the web 100 along a path of travel such that the second pouch 102b of the web 100 is positioned to become a padded envelope 201. In certain embodiments, the indexing mechanism 332 engages the left-over portions of the inflation channels 108, 110 that were used to inflate the previously removed pouches to move the web 100 along a path of travel. That is, for example, after pouch 102a was removed from the web 100 (as shown in FIGS. 10A-10C), the indexing mechanism 332 engages the portion of the inflation channels 108, 110 that were used to inflate pouch 102a to move the web 100 to a position in which the second pouch 102b can be inflated. The indexing mechanism moves the web in the direction X to place the second pouch 102b in position to be formed into a padded envelope 201. The web 100 is moved until the second pouch 102b is in the same position as first pouch 102a in FIGS. 4A-4C. The method shown in FIGS. 3A-11C can be continued until each pouch (e.g., pouches 102a-102d) is inflated and removed from the web 100 as a padded envelope 201. The inflatable packaging web 100 can include any suitable number of pouches 102.

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof. Unless expressly excluded herein, all such combinations and sub-combinations are intended to be within the scope of the general inventive concepts. Still further, while various alternative embodiments as to the various aspects, concepts and features of the inventions (such as alternative materials, structures, configurations, methods, circuits, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein.

Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated.

Moreover, while various aspects, concepts and features may be expressly identified herein as being inventive or forming part of an invention, such identification is not intended to be exclusive, rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1. An apparatus for converting a web of preformed pouches into at least one padded envelope, each of the preformed pouches being defined by side edges, a first side panel having a first inflation pattern, and a second side panel having a second inflation pattern, each of the preformed pouches having a first inflation channel in fluid communication with the first inflation pattern, a second inflation channel in fluid communication with the second inflation pattern, and an outer skin attached to an outer surface of the web of preformed pouches, the apparatus comprising;
an indexing mechanism configured to move the web of preformed pouches along a path of travel;
a first inflation pin configured to be placed into the first inflation channel of the preformed pouches and provide air into the first inflation channel to inflate the first inflation pattern of the first side panel of the preformed pouches;
a second inflation pin configured to be placed into the second inflation channel of the preformed pouches and provide air into the second inflation channel to inflate the second inflation pattern of the second side panel of the preformed pouches; and
a sealing member configured to seal the outer skin, the first side panel, and the second side panel simultaneously.

2. The apparatus according to claim 1, further comprising a printer for printing indicia on the outer skin of the preformed pouches.

3. The apparatus according to claim 1, further comprising a bursting member 303 for breaking a line of perforations between the preformed pouch and an adjacent preformed pouch to separate the preformed pouch from the adjacent preformed pouch.

4. The apparatus according to claim 1, wherein the sealing member is configured to partially close the preformed pouches prior to sealing the outer skin, the first side panel, and the second side panel simultaneously.

5. The apparatus according to claim 1, wherein the sealing member is configured to remove the preformed pouches from the web by using a heat trim that extends into at least one separation opening of the web that separates the preformed pouch from an adjacent preformed pouch.

6. The apparatus according to claim 1, further comprising a backing bar that is configured to provide a backing surface for the sealing member when the sealing member seals the outer skin, the first side panel, and the second side panel of the preformed pouch.

7. The apparatus according to claim 6, wherein the sealing member is configured to move between a first position in which the sealing member is not engaging the web of preformed pouches and a second position in which the sealing member engages the web of preformed pouches to seal the preformed pouches.

8. The apparatus according to claim 7, wherein the backing bar is fixed to the apparatus such that the backing bar is not movable relative to the apparatus.

9. The apparatus according to claim 7, wherein the backing bar is movable between a first position in which the backing bar is not positioned to provide the backing surface for the sealing member and a second position in which the backing bar is positioned to provide the backing surface to the sealing member.

10. The apparatus according to claim 1, wherein the sealing member is a heated bar.

11. An apparatus for converting a web of preformed pouches into at least one padded envelope, the web including one or more separation openings that separate each of the preformed pouches from an adjacent preformed pouch, each of the preformed pouches being defined by side edges, a first side panel having a first inflation pattern, and a second side panel having a second inflation pattern, each of the preformed pouches having a first inflation channel in fluid communication with the first inflation pattern, and a second inflation channel in fluid communication with the second inflation pattern, the apparatus comprising;
an indexing mechanism configured to move the web of preformed pouches along a path of travel;
a first inflation pin configured to be placed into the first inflation channel of the preformed pouches and provide air into the first inflation channel to inflate the first inflation pattern of the first side panel of the preformed pouches;
a second inflation pin configured to be placed into the second inflation channel of the preformed pouches and provide air into the second inflation channel to inflate the second inflation pattern of the second side panel of the preformed pouches; and
a sealing member configured to seal the first side panel to the second side panel such that the first and second inflation patterns of the preformed pouch are sealed, and wherein the sealing member is configured to remove the preformed pouches from the web by using a heat trim that extends into at least one separation opening of the one or more separation openings.

12. The apparatus according to claim 11, further comprising a printer for printing indicia on the preformed pouches.

13. The apparatus according to claim 11, wherein an outer skin is attached to an outer surface of the web of preformed pouches, and wherein the sealing member is configured to seal the outer skin, the first side panel, and the second side panel simultaneously.

14. The apparatus according to claim 11, further comprising a bursting member 303 for breaking a line of perforations between the preformed pouch and an adjacent preformed pouch to separate the preformed pouch from the adjacent preformed pouch.

15. The apparatus according to claim 11, wherein the sealing member is configured to partially close the preformed pouches prior to sealing the first side panel to the second side panel.

16. The apparatus according to claim 11, further comprising a backing bar that is configured to provide a backing surface for the sealing member when the sealing member seals the first side panel to the second side panel.

17. The apparatus according to claim 16, wherein the sealing member is configured to move between a first position in which the sealing member is not engaging the web of preformed pouches and a second position in which the sealing member engages the web of preformed pouches to seal the preformed pouches.

18. The apparatus according to claim 17, wherein the backing bar is fixed to the apparatus such that the backing bar is not movable relative to the apparatus.

19. The apparatus according to claim 17, wherein the backing bar is movable between a first position in which the backing bar is not positioned to provide the backing surface for the sealing member and a second position in which the backing bar is positioned to provide the backing surface to the sealing member.

20. The apparatus according to claim 11, wherein the sealing member is a heated bar.

21-26. (canceled)
